(19) United States
(12) Patent Application Publication
(10) Pub. No.: US 2013/0142612 A1
(43) Pub. Date: Jun. 6, 2013

(54) WHEEL-LESS PORTABLE SECURITY SYSTEM AND DEPLOYMENT THEREOF

(71) Applicant: Michael G. Monsive, JR., Cypress, TX (US)

(72) Inventor: Michael G. Monsive, JR., Cypress, TX (US)

(21) Appl. No.: 13/309,213

(22) Filed: Dec. 1, 2011

(51) Int. Cl. B65G 67/02; A47B 97/00; B60P 7/08

(52) U.S. Cl. 414/800; 410/80; 312/223.1

(57) ABSTRACT

Methods and apparatus for easy and efficient loading, transporting, unloading, and deployment of one or more mobile security systems are provided, as well as the security systems themselves. For some embodiments, the security systems may have rails that may be engaged with the forks of a forklift, such that the systems may be easily and quickly loaded on or unloaded from a vehicle for transportation of multiple systems. The vehicle may also be fitted with one or more docking devices, such that the security systems may be inserted into the docking devices and quickly secured in place without straps or chains. In this manner, multiple systems may be easily and efficiently delivered to and/or picked up from one or more sites when compared to conventional one-system-at-a-time deployment methods.

### BACKGROUND OF THE INVENTION

1. Field of the Invention

Embodiments of the present invention generally relate to surveillance systems and, more particularly, to mobile surveillance systems configured for easy deployment.

2. Description of the Related Art

Security systems have found applications in various areas. Homes, warehouses, retail stores, construction sites, banks, automated teller machines (ATMs), etc., all use security systems. Deployment of security systems may help detect and/or prevent intrusions, theft, vandalism, and other mishaps.

Security systems may be used to monitor new construction sites or remote installations, for example, which may be more prone to vandalism or theft. Such security systems may comprise security equipment like cameras, video recorders, and infrared devices to collect information about the remote installation or site.

Mobile security system users may require a plurality of devices and request simultaneous delivery at a particular site. For example, a party hosting a large public event may wish to have several portable security systems temporarily installed for the event, but removed shortly thereafter. Additionally, a distributor of such systems may want to deliver multiple systems at one time to various customers at various sites. Deploying security systems one at a time is very inefficient and costs a business time, money, manpower and in some cases, other business opportunities.

Accordingly, what is needed are techniques and apparatus for efficiently delivering multiple security systems.

### SUMMARY OF THE INVENTION

One embodiment of the invention is a method of transporting at least one mobile security system. The method generally includes providing at least one docking device coupled to a vehicle and inserting the mobile security system into the docking device at a first location for transportation.

Another embodiment of the invention provides a mobile security system. The mobile security system generally includes an enclosure, a mast attached to the enclosure, surveillance equipment coupled to the mast, and two rails coupled to the enclosure and configured for coupling with a docking device mounted on a vehicle, such that the mobile security system is secure in the docking device during transportation.

Yet another embodiment of the invention provides an apparatus for receiving a mobile security system. The apparatus generally includes a first rail and a second rail parallel to the first rail, wherein the first and second rails are configured to receive two corresponding rails of the mobile security system.

### BRIEF DESCRIPTION OF THE DRAWINGS

A more particular description of the invention, briefly summarized above, may be had by reference to the embodiments thereof which are illustrated in the appended drawings. It is to be noted, however, that the appended drawings illustrate only typical embodiments of the invention and are, therefore, not to be considered limiting in its scope, for the invention may admit to other equally effective embodiments.

FIG. 1 illustrates an internal view of a mobile security system in accordance with certain embodiments of the present disclosure.

FIG. 2 illustrates the mobile security system of FIG. 1 with stabilizer arms fully extended in accordance with certain embodiments of the present disclosure.

FIG. 3 illustrates a side view of the mobile security system of FIG. 1 in accordance with certain embodiments of the present disclosure.

FIG. 4 illustrates a mobile security system with stabilizer arms in a retracted position in accordance with certain embodiments of the present disclosure.

FIG. 5 illustrates a passageway for stabilizer arms in a mobile security system in accordance with certain embodiments of the present disclosure.

FIG. 6 illustrates a docking device for a mobile security system in accordance with certain embodiments of the present disclosure.

FIG. 7 illustrates a mobile security system engaged with the docking device of FIG. 6 in accordance with certain embodiments of the present disclosure.

FIG. 8 illustrates a plurality of mobile security systems engaged with docking devices mounted on a truck bed for transportation and deployment of the security systems in accordance with certain embodiments of the present disclosure.

FIG. 9 is a flow diagram of example operations for transporting at least one mobile security device in accordance with certain embodiments of the present disclosure.

### DETAILED DESCRIPTION

Certain embodiments of the present disclosure may provide a security system configured for easy deployment. The system may be configured in a manner that facilitates easy loading/unloading, secures the system on a vehicle for transportation, and reduces or eliminates interference between systems during transportation. Such a security system may therefore be suitable for a wide range of applications, including those that require multiple systems. Embodiments of the present disclosure enable efficient, easy deployment of multiple systems to one or more sites rather than delivering each system individually.

### An Example Wheel-Less Mobile Security System

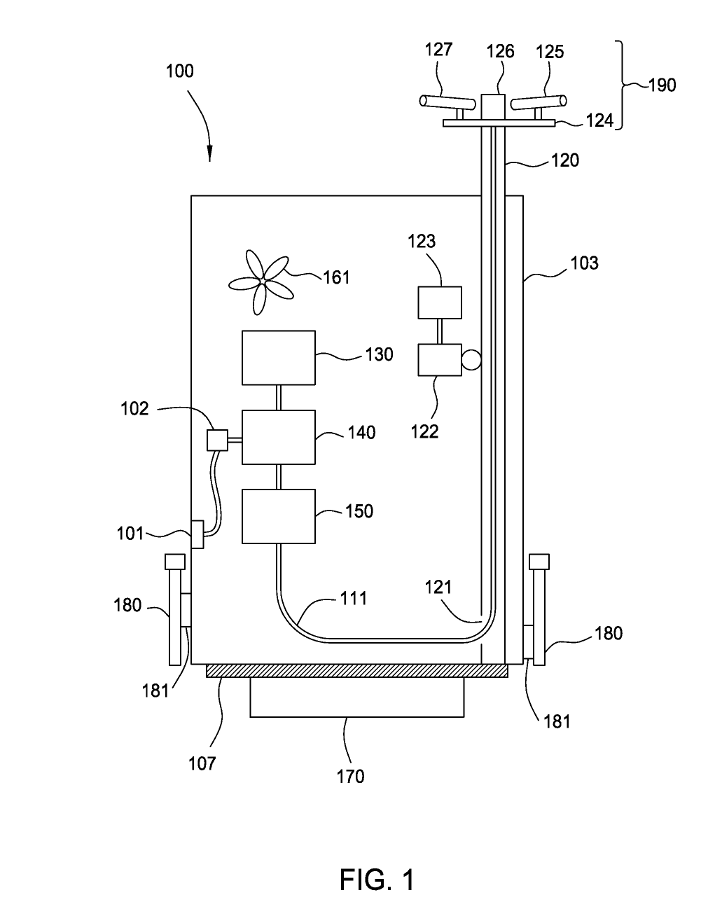

FIG. 1 shows a mobile security system 100 according to some embodiments of the present disclosure. The security system may be transported to and deployed in locations that may have no readily available power sources (e.g., construction sites), as well as to areas with an external power source, thereby expanding the number of suitable applications for such a system. In such locations, the security system 100 may be used, for example, to detect the presence of trespassers at a site, record their criminal activities with photographs or video, sound an audible alarm, alert authorities and/or a monitoring service, or any combination thereof. As illustrated in FIG. 1, the security system 100 may comprise an enclosure 103, legs 180 for supporting the enclosure 103 above the ground or other suitable surface, security equipment 190, a mast 120 for supporting the security equipment 190, rails 170 for engaging with a transportation device such as a forklift, and a suspended rail 170 for engaging with a deployment system such as a dock. The enclosure 103 may be constructed using any suitable materials, such as wood and/or metal.

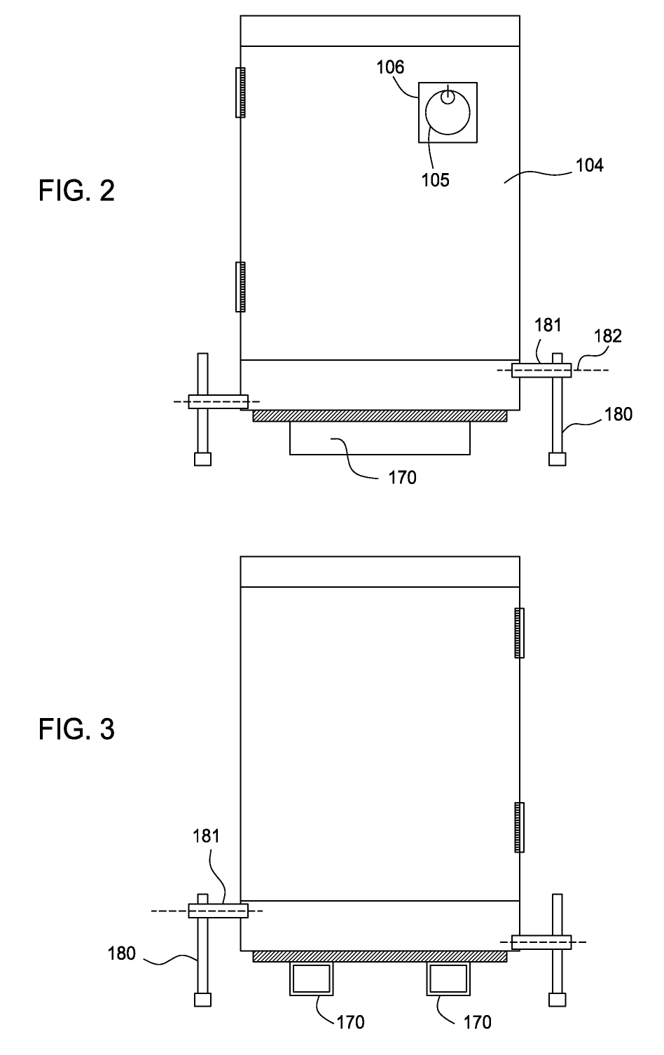

As shown in FIG. 2, the enclosure 103 may have a hinged front door 104 that opens to one side. The door 104 allows access to the internal components of system 100 and protects the internal components of system 100 when the system is engaged in surveillance or is not being accessed by a user. A lock 105 may be disposed within a recess 106 of door 104. Placing the lock 105 within the recess 106 prevents access by an intruder with a crowbar or other torque arm trying to break the lock 105. Other embodiments may use two doors on one side with a lock set in a recess where the doors meet. The enclosure 103 may also include a back door (not shown) for access to the internal components from the other side of the system 100.

The enclosure 103 may enclose a power generation unit 130, a rechargeable power source 140, and a processing unit 150. The power generation unit 130 may comprise any of various suitable power sources, such as generators that convert mechanical energy into electrical energy, solar cells that may convert mechanical energy into electrical energy, etc., used alone or in combination. The rechargeable power source 140 may be any of various suitable devices capable of being repeatedly recharged and supplying sufficient power. For some embodiments, the power generation unit 130 may comprise an engine driving an alternator to charge the rechargeable power source 140, similar to the engine/alternator/battery combination in a modern automobile. In such embodiments, the engine may comprise a diesel engine or an internal combustion engine (ICE) using any suitable fuel source, such as gasoline. The engine may comprise a single-cylinder or multiple cylinders and may be liquid-cooled or air-cooled. In addition to the engine and alternator, such a charging power source may include a fuel tank, an engine speed regulator, an alternator voltage regulator, cooling and exhaust systems, and a lubrication system.

The rechargeable power source 140 may be configured to power the security equipment 190 and the processing unit 150. For some embodiments, the rechargeable power source 140 may comprise one or more rechargeable batteries. Any of various types of rechargeable batteries may be used. For example, the rechargeable power source 140 may comprise one or more gel batteries (also known as gel cells), which contain battery acid in a gel form. For other embodiments, the rechargeable power source 140 may comprise other types of lead-acid batteries, such as one or more absorbent glass mat (AGM) lead-acid batteries. Terminals of the rechargeable power source 140 may be connected with the security equipment 190 and the processing unit 150 via cable 111 in an effort to provide power to the components of the system 100. If the rechargeable power source 140 malfunctions or fails to hold a charge, the processing unit 150 may be configured to bypass the rechargeable power source 140 and directly power the components of the mobile security system 100.

In some situations, mobile security devices are deployed to sites, such as sporting events or construction sites nearing completion, that have electricity. An AC power outlet 101 may be configured to receive electricity from an extension cord, for example. The AC power outlet 101 may be connected to rechargeable power source 140 via an AC-to-DC converter device 102. If the rechargeable power source 140 malfunctions or fails to hold a charge, the processing unit 150 may be configured to allow an AC power supply connected to the AC power outlet 101 to bypass the rechargeable power source 140 and directly power the components of the mobile security system 100.

The mobile security system 100 may comprise security equipment 190 that may include any combination of a camera 125 (e.g., a still or a video camera), a loudspeaker 126, a motion sensor 127, and a flashing light or lights for some embodiments. The security equipment 190 may be mounted on a base 124, which may be attached to the mast 120 by any suitable means. The security equipment 190 may comprise means for collecting information about the site in which the security system 100 is deployed. For some embodiments, the security equipment 190 may comprise one or more surveillance cameras. A variety of cameras may be used. For example, some embodiments may use pan/tilt/zoom (PTZ) cameras or fixed cameras with built-in infrared (IR) for nighttime imaging. The collected information may be processed onsite by the processing unit 150. The collected information may be stored in a memory of the camera 125 or in a memory coupled to the processing unit 150. A fan 161 may cool the processing unit 150 and other components internal to the enclosure 103. For some embodiments, the security equipment 190 may comprise any of various devices for detecting sound and/or motion such as audio recorders, motion sensors employing, e.g., lasers, or infrared sensors. Some embodiments may use security equipment suitable for use in harsh environments involving high humidity and/or extreme temperatures. As shown in FIG. 1, the security equipment 190 is connected to the power sources 130, 140 and processing unit 150 via the cable 111.

Certain embodiments of the present disclosure may provide means for the mast 120 supporting the security equipment 190 to move to a suitable height above the unit in an effort to offer a clear view of a large surveillance area. The mast 120 may be removable from or statically mounted to the enclosure 103. For some embodiments, the mast 120 may have a fixed length. For other embodiments, the mast may be a telescoping structure that may allow the height of the security equipment 190 to be adjusted. For example, a galvanized two-section telescoping pole with adjustable height may be used. The means for telescoping the mast 120 may include electric winches, air cables, manual winches, twist lock, etc. For example, the height of the mast may be adjusted using a dual winch system. The embodiment displayed in FIG. 1 includes a winch 122 coupled to the mast 120 for adjusting the height of the mast 120. The winch 122 may be powered by a driver 123. The driver 123 may be an electric motor or a manual device, such as a hand crank. For some embodiments, the mast 120 is tubular, and the cable 111 runs through the mast 120. The mast 120 may have a hole 121 in an outer surface to allow the cable 111 to exit the center of the mast 120, preventing the cable 111 from being crushed under the weight of the mast 120 if the cable 111 were to exit at the bottom of the mast 120.

The security equipment 190 may be connected to processing unit 150 via cable 111 so that the processing unit 150 may perform different video processing functions, such as video recording, image processing, time stamping, and video encoding. For example, the video processing unit may comprise a digital video recorder (DVR) or a video cassette recorder (VCR). Video and other signals from the security equipment 190 may be input to the processing unit 150 via the cable 111. Furthermore, the processing unit 150 may control operation of the security equipment 190 via cable 111. For example, such control operations may include panning, tilting, or zooming operations of one or more cameras composing the security equipment 190.

The system 100 may include one or more alarms and means for activating the alarms. For example, a motion detector may be coupled with an audible or silent alarm to trigger the alarm when suspicious activity is detected. For some embodiments, the system 100 may comprise means for activating a remote siren that may be mounted away from the rest of the security system. For some embodiments, the alarm may include a constant or flashing light that turns on in an effort to deter trespassers and/or assist the camera(s) with imaging.

For some embodiments, the security system may comprise means for transmitting the collected and/or processed information to a different location to facilitate remote monitoring. For example, the security system may include high speed cellular, two-way radios, General Packet Radio Service (GPRS), Enhanced Data rates for Global Evolution (EDGE), satellite, Wi-Fi (IEEE 802.11), WiMAX (Worldwide Interoperability for Microwave Access) (IEEE 802.16), mesh, and/or local area network (LAN) capabilities to transmit the information to a remote location for monitoring or further processing. The system may have means to reboot a high speed cellular device if a connection is lost. The system may also include a means to view the data from the system in a remote location via a website, for example. Certain embodiments may include integrated global positioning system (GPS) tracking for increased functionality and security.

For some embodiments, the security system may send an e-mail, text message (Short Message Service, or SMS), or a paging notification to a remote site, personal computer (PC), server, or mobile device whenever an alarm has been triggered in an effort to alert someone. This message may include a video or a camera snapshot of the monitored site starting from when the alarm was triggered or shortly thereafter. For some embodiments, an alarm may activate a two-way radio that will allow someone at a remote site to communicate with an intruder via the loudspeaker 126 and/or hear what is occurring at the location of the deployed system.

Some embodiments may provide means for supporting the security system 100 above a surface (e.g., up off the ground) and/or for stabilizing the security system 100. For example, FIG. 1 illustrates legs 180 and extender arms 181. The legs 180 may be mounted to the ends of the arms 181 by a means that allows the height of the legs 180 to be adjusted up or down, allowing the legs 180 to be lengthened or shortened relative to system 100. FIG. 2 displays the arms 181 fully extended with the legs 180 in the down position. The legs 180 may rotate around the arms 181 allowing the legs 180 to be set in either an upright or an inverted position. For some embodiments, the legs 180 may be set at any angle. For other embodiments, the legs may be fixed relative to the arms, and each arm 181 itself may be rotated along a longitudinal axis 182, permitting the legs 180 to be set at any angle. The legs 180 and arms 181 may be locked in place once adjusted to a desired position by any suitable means, such as pins or set screws. The legs 180 may stabilize the entire structure of the security system 100 and prevent the system from being blown down or knocked over. During transportation, the legs 180 may be rotated up (i.e., inverted) to prevent interference with a docking device or damage to the legs. The legs 180 may then be rotated down (i.e., positioned upright) when the system 100 is deployed at a site.

The height of the legs 180 may be individually or jointly adjustable in an effort to make the security system 100 suitable for deployment in large areas. Height adjustability of the legs may further facilitate deployment of the security system on slopes and uneven surfaces. For example, tipping of the security system 100, when placed on a slope, may be avoided by adjusting individual heights of the legs 180 and therefore maintaining the security system 100 at a suitable angle with respect to the surface of the slope in an effort to prevent tipping. In other words, the security system 100 may be leveled by individually adjusting the height of the legs 180. Proper selection of the legs 180 may even prevent skidding of the system 100 when placed on a slope.

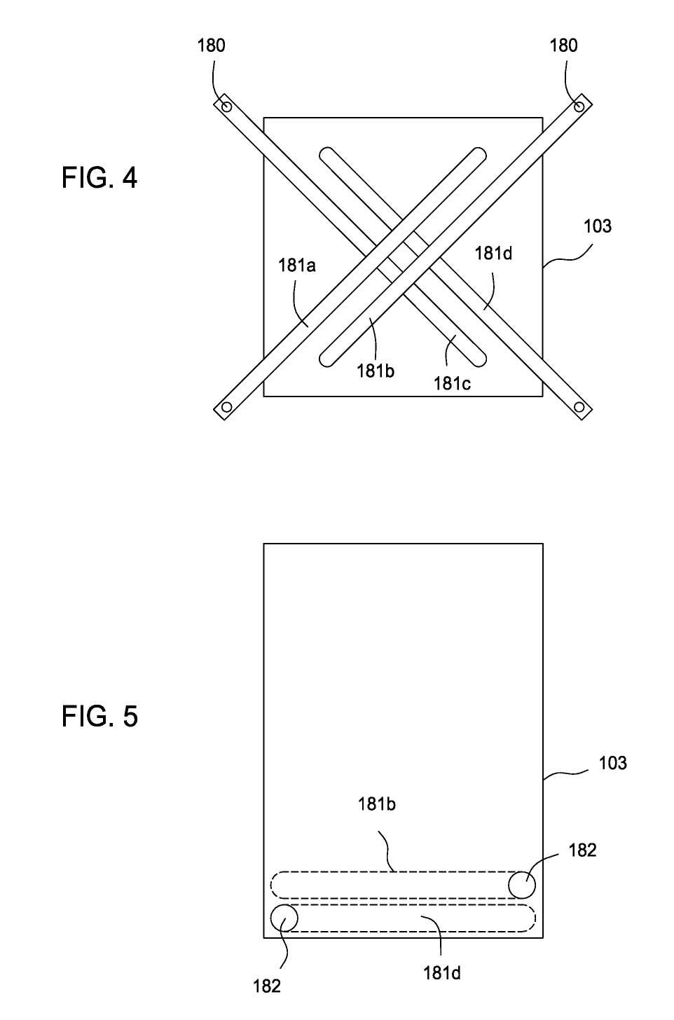

For some embodiments, the arms 181 may extend the diagonal length substantially across the system 100, as shown in FIG. 4. To allow all four arms 181 to extend nearly the full diagonal length of the system 100, two of the arms 181a, 181b may be positioned in a plane above another pair of arms 181c, 181d. Positioning the arms 181 diagonally and in different planes allows for greater extension by each arm 181 rather than just half of the diagonal length of the system 100, if all four arms resided in the same plane. As shown in FIG. 5, positioning the arms 181a, 181b above arms 181c, 181d has the arms extending out of holes 184 in the enclosure 103 at different heights. The legs 180 are independently vertically adjustable and may compensate for the difference in initial height of the arms 181. For some embodiments, even with the arms 181 fully extended, the system 100 may fit into a single standard parking space for a car.

For some embodiments, the system 100 may comprise means to facilitate transportation and/or deployment of the system, such as means to engage with a lifting device (e.g., a forklift) and means to engage with a docking device. As illustrated in FIG. 1 and shown more clearly in FIG. 3, rails 170 may serve as both means and may be mounted to the bottom surface of the enclosure 103. For some embodiments, the rails 170 may be mounted to the bottom surface of the enclosure 103 via at least one mount 107. The rails 170 may be designed in a manner to allow the forks of a forklift to slide in. This permits easy loading and unloading of the system 100 on and from, respectively, some form of transportation, such as a truck, a boat, or a railcar.

### An Example Docking Device

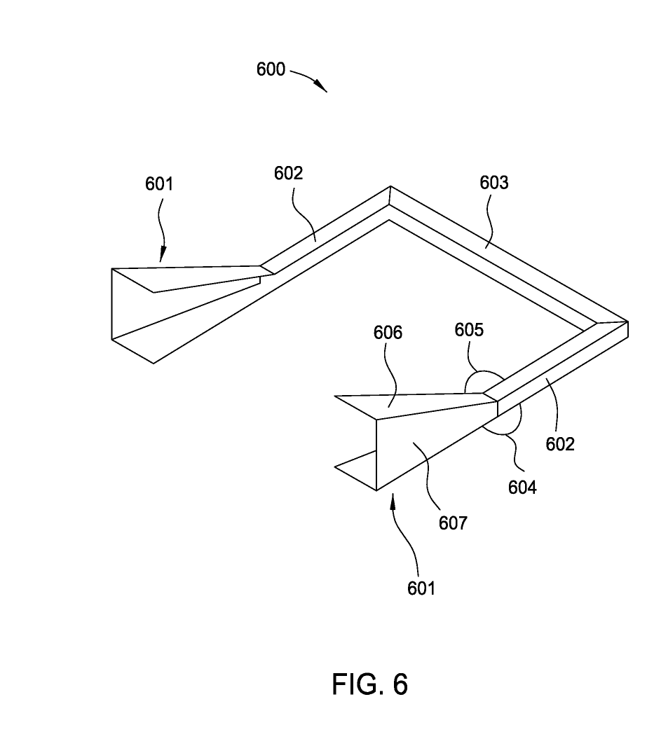

FIG. 6 displays a dock 600 for use in transporting a system 100 on a substantially flat surface, such as on a bed of a flatbed truck. The dock 600 may comprise receiving guides 601, side rails 602 and a back rail 603. The guides 601 may be attached to an end of rails 602 by a means such as welding. The rails 602 may be attached to opposite ends of back rail 603 by a means such as welding. For some embodiments, the dock 600 may be machined or otherwise fabricated as a single piece. The side rails 602 and the back rail 603 may have an L-shaped or C-shaped cross-section. For some embodiments, the back rail 603 may comprise a solid bar or have only a single wall.

For some embodiments, lateral surfaces 607 of the guides 601 may be flared out relative to rails 602 at an angle 604. Also for some embodiments, upper surfaces 606 of the guides 601 may be flared up relative to the side rails 602 at an angle 605. The receiving guides 601 may be flared in this manner to create a guide for a forklift operator to slide a system 100 between side rails 602 and up to the back rail 603 of the dock 600. For other embodiments, the guides 601 may be absent, such that the forklift operator may most likely align the suspended rails 170 with the side rails 602 before pushing the security system 100 into the dock 600.

The side rails 602 and the back rail 603 may have a means for receiving and coupling with a security system 100 that is inserted into dock 600 by any suitable means, such as a forklift. The suspended rails 170 may be secured in the side rails 602 and/or back rail 603 using any suitable means such as locking pins, set screws, or bolting, for example. In this manner, the security system may be easily and quickly secured in the dock 600 for transportation without the use of straps, chains, or other tie-down mechanisms.

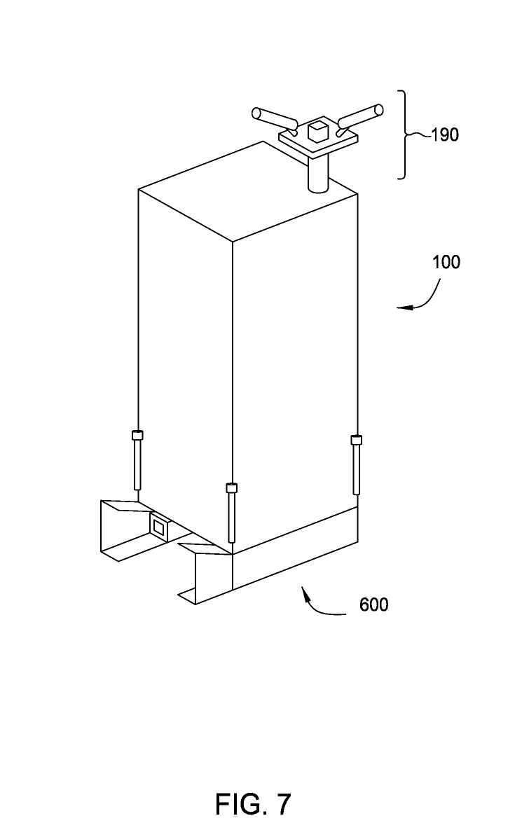

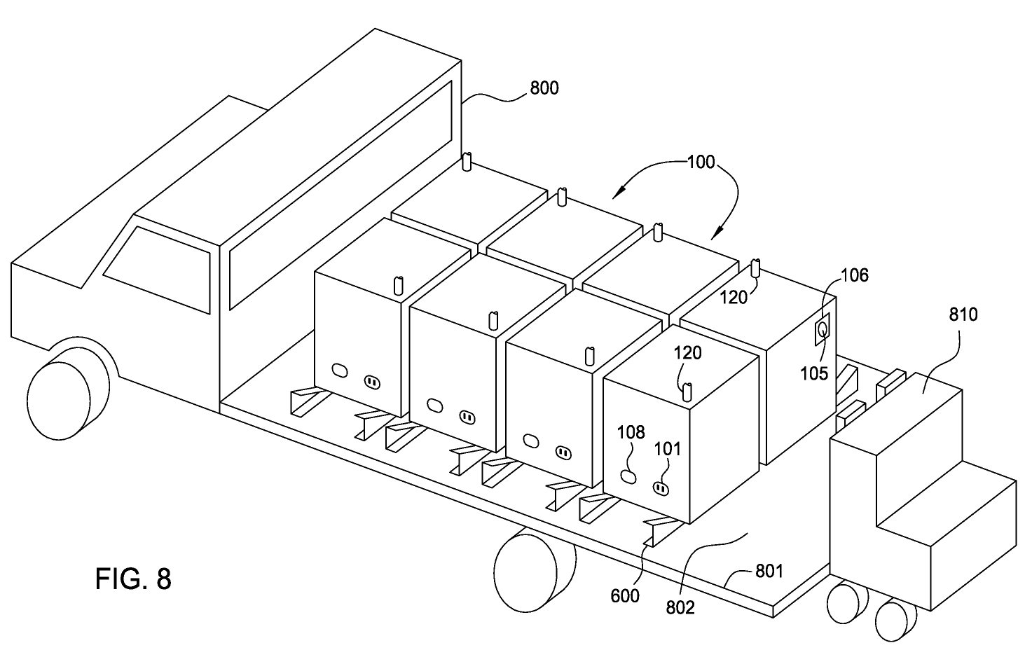

FIG. 7 shows the dock 600 fully engaged with the system 100. The legs 180 may most likely be inverted (i.e., in the rotated up position) while the security system 100 is in the dock 600.

FIG. 7 also displays an embodiment of the system 100 having the security equipment 190 offset to one corner of the enclosure 103. Offsetting the security equipment 190 and mast 120 to one corner of the enclosure 103 allows for more space inside of the enclosure 103 for the internal components of the system 100. Additionally, offsetting the equipment 190 to one corner permits a plurality of docks 600 engaged with systems 100 to be placed in two rows on a flatbed truck 800 as displayed in FIG. 8 without equipment 190 from two adjacent systems 100 colliding with or rubbing against each other during transportation. The embodiment displayed in FIG. 8 displays the systems 100 with a small space between each system, preventing access to the locked front doors 104 of all but one system 100 by an intruder if the systems are loaded on an unguarded truck 800.

The embodiment displayed in FIG. 8 allows multiple security systems 100 to be transported and deployed to sites. The docks 600 are mounted to the bed 802 of the truck 800 by any of various suitable means for securing the docks, such as bolting. For some embodiments, the docks 600 may be bolted to the bed 802, either using the rails 602, 603 and/or guides 601 or by bolting down plates or other structures welded to the rails 602, 603 and/or guides 601. The systems 100 may be designed such that up to eight systems, for example, may be loaded on a flatbed truck without exceeding the gross vehicle weight rating (GVWR) required for a commercial driver's license (CDL).

For some embodiments, the security system 100 may include fuel tanks. If fills for the fuel tanks are positioned in a lateral surface of the enclosure 103 such that the fills 108 face the driver or passenger side 801 of the truck bed as illustrated in FIG. 8 (as opposed to facing an adjacent security system or the cab of the truck), the operator of the truck 800 may stop at a fueling station and have easy access to all of the fuel tank fills 108 of the systems 100, without having to unload any of the security systems 100 to refuel. Similarly, the AC power outlets 101 may be positioned in a lateral surface of the enclosure 103 such that the outlets 101 face the driver or passenger side 801 of the truck bed as illustrated in FIG. 8 (as opposed to facing an adjacent security system or the cab of the truck). In this manner, an operator may have easy access to the AC power outlets 101 for extension cords to charge rechargeable power source 140 or to directly power the system 100. As depicted in FIG. 8, the fuel tank fills 108 and AC power outlets 101 may be on the same surface of the enclosure 103. For some embodiments, the fuel tank fills and/or the AC power outlets 101 may be on the top surface of the enclosure 103 for easy access once the security systems 100 have been loaded on a vehicle.

### Example Operations for Transporting the Wheel-Less Portable Security System

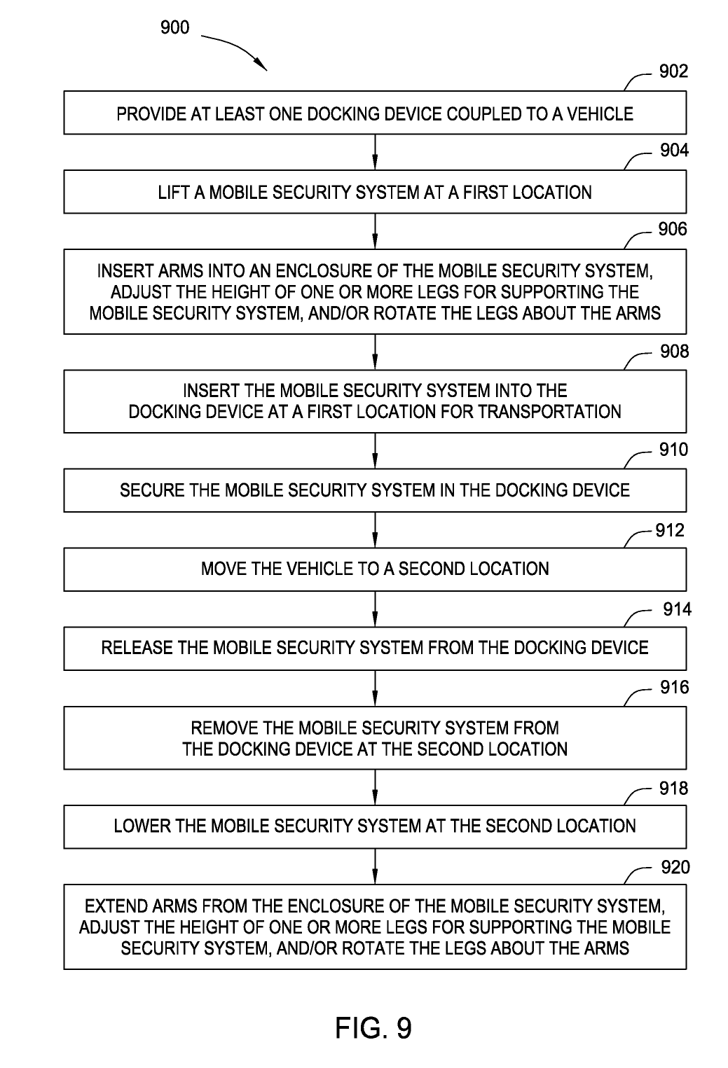

FIG. 9 is a flow diagram of example operations 900 for transporting at least one mobile security device in accordance with certain embodiments of the present disclosure. Although only a flatbed truck 800 is described below, these operations may apply to any of various suitable vehicles including a boat or a train railcar. The operations 900 may begin, at 902, by providing at least one docking device (e.g., dock 600) coupled to the truck 800.

To begin loading operations at a first location, a forklift operator may drive a forklift 810 up to a mobile security system 100 and insert forks 811 of the forklift 810 into the suspended rails 170. At 904, the forklift 810 may lift the system 100 such that the legs 180 may be rotated up (i.e., inverted) and the arms 181, if extended, may be pushed into the enclosure 103 at 906 such that the legs may be disposed against the enclosure for transportation. In order to insert an arm 181, a spring-loaded pin (not shown) may be pulled out of the arm 181 such that the arm may be moved. Once the arm 181 reaches a suitable position for transportation of the security system 100, the spring-loaded pin may be released and may lock the position of the arm 181. This process may be repeated for each of the arms 181. The height of the legs 180 may be adjusted at 906 before or after rotating the legs or before or after pushing the arms 181 into the enclosure, typically to shorten the legs for transportation.

Once the arms 181 and legs 180 have been adjusted, the forklift operator may drive toward a dock 600 mounted on the bed 802 of the truck 800. The forklift may be driven substantially close to being directly in front of one of the docks 600 and may then lift the system 100 to a height just above the height of the bed 802, such that the suspended rails 170 at least approximately line up with the side rails 602 of the dock 600. At 908, the forklift 810 may be driven toward the dock 600 and the suspended rails 170 of the security system 100 may begin to engage with the guides 601 of the dock 600. The guides 601 may help align the system 100 with the dock 600 so that the system will slide between the side rails 602 and up to the back rail 603 as the forklift moves toward the truck 800. The forklift operator may then back up and lower the forks 811 of the forklift 810, leaving the system 100 engaged with the dock 600. In this manner, the system 100 may be inserted into the dock 600 at the first location. For some embodiments, the operator may, at 910, secure the system 100 to the dock 600 by any of various suitable means for this purpose, such as inserting locking pins into holes that line up in the suspended rails 170 of the system 100 and the side rails 602 of the dock 600.

The process described above may be repeated until the desired number of security systems 100 have been loaded onto the truck 800 or until security systems have been loaded into all of the available docks 600 on the bed 802. Once all of the systems 100 have been loaded onto the truck 800, the forklift 810 may be mounted on or attached to the rear end of the truck 800, for example, for use when unloading the systems.

At 912, the truck 800 may be moved to a second location, such as a site to be monitored by one of the security systems 100. When the truck 800 reaches the second location, the forklift 810 may be removed from (the back of) the truck 800 and driven up to one of the systems 100. The means for securing the system 100 to the corresponding dock 600 (e.g., locking pins) may be removed, released, or otherwise unsecured at 914. The forks 811 of the forklift 810 may be inserted into the rails 170 of the system, and the forklift 810 may then back up and remove the system 100 from the truck 800 at 916. Typically, the system 100 suspended on the forks 811 may be lowered closer to the ground at 918 in an effort to lower the center of gravity while the forklift 810 is moving.

The forklift 810 may then be driven to the desired location at the site where the system is to be deployed. At the desired location, the forklift 810 may further lower the system 100 close enough to the ground for the legs 180 to touch the ground once rotated down and height adjusted without the system 100 resting on the rails 170. From this suspended position, the legs 180 of the system 100 may be rotated down and locked into place at 920, and the height of the legs may be adjusted. Furthermore, one or more of the arms 181 may be extended away from the enclosure 103. Then, the forklift 810 may back up and disengage with the system 100, allowing the system 100 to stand freely on the legs 180.

The system 100 may then be powered on by starting the power generation unit 130, connecting an AC power supply to the AC outlet 101, using power from the rechargeable power source 140 or any combination of these. The mast 120 may be raised to position the security equipment 190 at a suitable height. The system 100 may then monitor the site. This unloading and deployment process may be repeated for each system 100 to be deployed at each site.

After a system 100 is no longer needed at a site, a truck may return to the site and the loading operations may be repeated. If the mast 120 has been raised, the mast may be lowered before the system 100 is loaded on the truck.

While the foregoing is directed to embodiments of the present invention, other and further embodiments of the invention may be devised without departing from the basic scope thereof, and the scope thereof is determined by the claims that follow.

1. A method of transporting at least one mobile security system, comprising:
providing at least one docking device coupled to a vehicle; and
inserting the mobile security system into the docking device at a first location for transportation.

2. The method of claim 1, further comprising securing the mobile security system in the docking device for transportation.

3. the method of claim 2, wherein securing the mobile security system in the docking device comprises inserting one or more locking pins into the docking device.

4. The method of claim 1, wherein the docking device secures the mobile security system in place for transportation without straps, chains, or other tie-down mechanisms.

5. The method of claim 1, further comprising:
lifting the mobile security system with a forklift at the first location; and
aligning the mobile security system with the docking device, wherein inserting the mobile security system comprises driving the forklift toward the docking device.

6. The method of claim 5, further comprising at least one of inserting arms into an enclosure of the mobile security system, adjusting the height of one or more legs for supporting the mobile security system, or rotating the legs about the arms of the mobile security system.

7. The method of claim 1, further comprising:
moving the vehicle to a second location; and
removing the mobile security system from the docking device at the second location.

8. The method of claim 7, further comprising:
lowering the mobile security system with a forklift at the second location; and
aligning the forklift with the docking device, wherein removing the mobile security system comprises backing the forklift away from the docking device.

9. The method of claim 8, further comprising at least one of extending arms from an enclosure of the mobile security system, adjusting the height of one or more legs for supporting the mobile security system, or rotating the legs about the arms of the mobile security system.

10. The method of claim 1, wherein the vehicle comprises a truck having a flat bed, the at least one docking device comprises eight docking devices coupled to the flat bed of the truck, and the at least one mobile security system comprises eight mobile security systems secured in the eight docking devices for transportation on the truck.

11. A mobile security system comprising:
an enclosure;
a mast attached to the enclosure;
surveillance equipment coupled to the mast; and
two rails coupled to the enclosure and configured for coupling with a docking device mounted on a vehicle, such that the mobile security system is secure in the docking device during transportation.

12. The system of claim 11, wherein the two rails are configured to engage with forks of a forklift for lifting and lowering the mobile security system.

13. The system of claim 11, further comprising:
arms extending from the enclosure, wherein extension of the arms from the enclosure is adjustable; and
legs for supporting the mobile security system coupled to the arms, wherein the height of the legs is adjustable and the legs are rotatable around the arms.

14. An apparatus for receiving a mobile security system, comprising:
a first rail; and
a second rail parallel to the first rail, wherein the first and second rails are configured to receive two corresponding rails of the mobile security system.

15. The apparatus of claim 14, wherein the first and second rails have a C-shaped cross section.

16. The apparatus of claim 14, further comprising a third rail coupled to the first and second rails.

17. The apparatus of claim 14, further comprising means for securing the mobile security system to the apparatus.

18. The apparatus of claim 14, further comprising means for securing the apparatus to a vehicle.

19. The apparatus of claim 14, further comprising one or more guides, each of the guides coupled to one of the rails.

20. The apparatus of claim 19, wherein the guides are flared relative to the side rails.
